(19) United States
(12) Patent Application Publication
(10) Pub. No.: US 2025/0308759 A1
(43) Pub. Date: Oct. 2, 2025

(54) COIL DEVICE

(71) Applicant: TDK CORPORATION, Tokyo (JP)

(72) Inventors: Kyosuke INUI, Tokyo (JP); Koji Shimura, Tokyo (JP); Hirofumi Sasaki, Tokyo (JP); Ryuji Ando, Tokyo (JP)

(73) Assignee: TDK CORPORATION, Tokyo (JP)

(21) Appl. No.: 19/089,224

(22) Filed: Mar. 25, 2025

(30) Foreign Application Priority Data
Mar. 29, 2024 (JP) 2024-057781

(51) Int. Cl. H01F 27/30; H01F 17/04; H01F 27/255; H01F 27/28

(52) U.S. Cl. CPC H01F 27/306; H01F 17/04; H01F 27/255; H01F 27/2823

(57) ABSTRACT

Provided in a coil device including: a first magnetic material portion having a plate-shaped portion and a protrusion protruding from the plate-shaped portion; a wire having a winding portion forming a winding layer wound around the protrusion; and a second magnetic material portion containing a magnetic material and a resin and covering at least the winding portion and the protrusion, in which a first average gap width, which is an average gap width of a first layer directly wound around the protrusion, is wider than a second average gap width of a second layer wound around the protrusion while overlapping the first layer in the winding portion, and a first layer protrusion gap width, which is a gap along a second direction between the protrusion and a first layer uppermost wire cross section is narrower than the first average gap width, in a predetermined cross section including a winding axis.

### BACKGROUND OF THE INVENTION

### 1. Technical Field

The present invention relates to a coil device used as an inductor element or the like.

### 2. Description of the Related Art

As a coil device, a combination of two types of core portions having different content ratios of resin and magnetic material and a winding portion has been proposed. In such a coil device, by using two types of core portions having different content ratios of resin and magnetic material, it is possible to relax stress and prevent occurrence of cracks.

In such a coil device, a magnetic material is disposed so as to cover the winding portion, which is advantageous from the viewpoint of improving inductance. However, in such a coil device, particles constituting the core portion having a large resin content ratio among the two types of core portions and having fluidity may move into the winding portion at the time of compression or the like in the manufacturing process. During such movement of the particles, friction with the insulating coating of the wire constituting the winding portion may occur, and the insulating coating of the wire may be damaged.

### CITATION LIST

### Patent Literature

Patent Literature 1: JP 2017-199734 A
Patent Literature 2: JP 2020-113742 A

### SUMMARY OF THE INVENTION

The present disclosure has been made in view of such circumstances, and provides a coil device that prevents damage to a coating portion of a wire.

A coil device according to the present disclosure includes:
a first magnetic material portion containing a magnetic material and having a plate-shaped portion and a protrusion protruding from the plate-shaped portion;
a wire having a winding portion including a conductor portion and an insulating coating portion covering the conductor portion and forming a winding layer wound around the protrusion; and
a second magnetic material portion containing a magnetic material and a resin and covering at least the winding portion and the protrusion,
in which a first average gap width, which is an average gap width along a first direction away from the plate-shaped portion between wire cross sections included in a first layer directly wound around the protrusion in the winding portion, is wider than a second average gap width, which is an average gap width along the first direction between the wire cross sections included in a second layer wound around the protrusion while overlapping the first layer in the winding portion, and
a first layer protrusion gap width, which is a gap width along a second direction perpendicular to a winding axis between a first layer uppermost wire cross section farthest from the plate-shaped portion among the wire cross sections included in the first layer and the protrusion, is narrower than the first average gap width, in a predetermined cross section including the winding axis of the winding portion in which the wire cross sections, which are cross sections of the wire, are observed.

In the coil device according to the present disclosure, since the first average gap width is wider than the second average gap width, the first layer is suitably pressed against the protrusion by the second layer. Such a coil device can prevent particles of the second magnetic material portion from entering the inside of the winding portion and can suitably prevent damage of the wire and short circuit failure associated therewith. By narrowing the first layer protrusion gap width, it is possible to prevent particles of the second magnetic material portion from entering the inside of the winding portion. By narrowing the second average gap width, the winding portion can be disposed compactly, and the magnetic characteristics of the coil device can be improved.

For example, a first layer upper gap width, which is a gap width along the first direction between the first layer uppermost wire cross section and a first layer second-stage wire cross section adjacent to the first layer uppermost wire cross section in the first direction, may be narrower than the first average gap width.

By narrowing the first layer upper gap width, it is possible to suppress positional displacement of the first layer uppermost wire cross section during compression molding and to prevent a problem that the coating layer of the first layer uppermost wire cross section itself is damaged.

For example, a first layer upper gap width along the first direction between the first layer uppermost wire cross section and a first layer second-stage wire cross section adjacent to the first layer uppermost wire cross section in the first direction may be wider than the first average gap width.

In such a coil device, since the first layer uppermost wire cross section is effectively pressed toward the protrusion by the wire cross sections of the second layer, it is possible to prevent particles of the second magnetic material portion from entering the inside of the winding portion.

For example, the first layer uppermost wire cross section may include a portion separated from the plate-shaped portion as compared with a protrusion tip farthest from the plate-shaped portion of the protrusion.

In the coil device having such a winding portion, since the first layer uppermost wire cross section is effectively pressed toward the protrusion by the wire cross sections of the second layer, it is possible to prevent particles of the second magnetic material portion from entering the inside of the winding portion.

For example, a second layer uppermost wire cross section farthest from the plate-shaped portion among the wire cross sections included in the second layer may be closer to the plate-shaped portion than the first layer uppermost wire cross section.

The coil device having such a winding portion is less likely to cause winding collapse of the winding portion, and can more suitably prevent the magnetic material powder of the second magnetic material portion from entering the inside of the winding portion.

For example, a distance along the first direction between a first layer lowermost wire cross section closest to the plate-shaped portion among the wire cross sections included in the first layer and the first layer uppermost wire cross section may be longer than a distance along the first direction between a second layer lowermost wire cross section closest to the plate-shaped portion among the wire cross sections included in the second layer and a second layer uppermost wire cross section farthest from the plate-shaped portion among the wire cross sections included in the second layer.

Such a coil device can prevent particles of the second magnetic material portion from entering the inside of the winding portion and can suitably prevent damage of the wire and short circuit failure associated therewith. By disposing the entire second layer at a short distance, the winding portion can be formed compactly, and the magnetic characteristics of the coil device can be improved.

### BRIEF DESCRIPTION OF THE DRAWINGS

FIG. 1 is a partial perspective view of a coil device according to an embodiment of the present disclosure;

FIG. 2 is a cross-sectional view of the coil device illustrated in FIG. 1;

FIG. 3 is an enlarged cross-sectional view in which the periphery of a winding portion in the cross section illustrated in FIG. 2;

FIG. 4 is a conceptual diagram illustrating a definition of a gap width related to a first layer and a second layer in the winding portion illustrated in FIG. 3;

FIGS. 5A and 5B are conceptual diagrams illustrating a shape of a first layer according to first and second modifications;

FIGS. 6A and 6B are conceptual diagrams illustrating a shape of a first layer according to third and fourth modifications; and

FIGS. 7A and 7B are conceptual diagrams illustrating a shape of a first layer according to fifth and sixth modifications.

### DETAILED DESCRIPTION

Hereinafter, embodiments of the present disclosure will be described with reference to the drawings. The illustrated contents are only schematically and exemplarily shown for understanding of the present disclosure, and the appearance, dimensional ratios, and the like may be different from the actual ones. The present disclosure is not limited to the following embodiments.

### First Embodiment

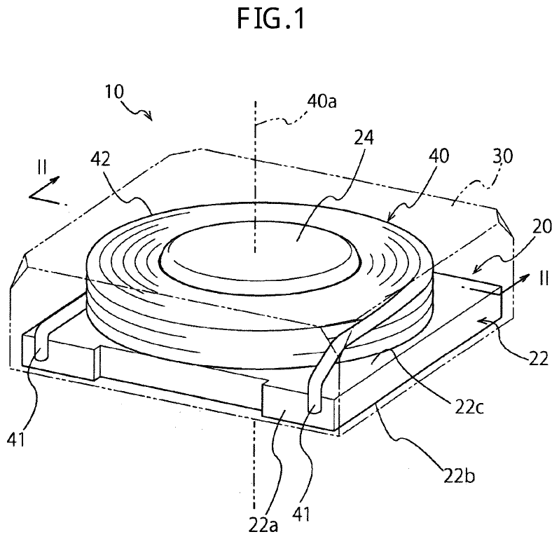

FIG. 1 is a partial perspective view of a coil device 10 according to an embodiment of the present disclosure. As illustrated in FIG. 1, the coil device 10 includes a first magnetic material portion 20, a second magnetic material portion 30, and a wire 40. The coil device 10 includes a pair of terminal electrodes (not illustrated in FIG. 1) connected to the wire 40. In FIG. 1, in order to understand an internal structure of the coil device 10, the second magnetic material portion 30 is displayed as an imaginary line in a see-through manner.

As illustrated in FIG. 1, the coil device 10 has a substantially rectangular parallelepiped outer shape, and the first magnetic material portion 20 is disposed near a bottom surface of the coil device 10. The first magnetic material portion 20 contains a magnetic material, and has a plate-shaped portion 22 having a substantially rectangular tabular shape and a columnar protrusion 24 protruding upward from a center portion of the plate-shaped portion 22.

The first magnetic material portion 20 includes, for example, a sintered core made of a magnetic material not containing a resin, a core containing a resin and a magnetic material formed by compression molding or injection molding granules containing a magnetic material powder constituting the magnetic material and a resin as a binder, and the like. The magnetic material powder is not particularly limited, and a metal magnetic material powder such as Sendust (Fe—Si—Al; iron-silicon-aluminum), Fe—Si—Cr (iron-silicon-chromium), Permalloy (Fe—Ni), carbonyl iron-based, carbonyl Ni-based, amorphous powder, or nanocrystal powder is preferably used.

However, the magnetic material powder may be a ferrite magnetic material powder such as Mn—Zn or Ni—Cu—Zn. When the first magnetic material portion 20 contains a magnetic material and a resin, a binder resin contained in the first magnetic material portion 20 is not particularly limited, and examples thereof include an epoxy resin, a phenol resin, an acrylic resin, a polyester resin, polyimide, polyamideimide, a silicon resin, and a combination thereof.

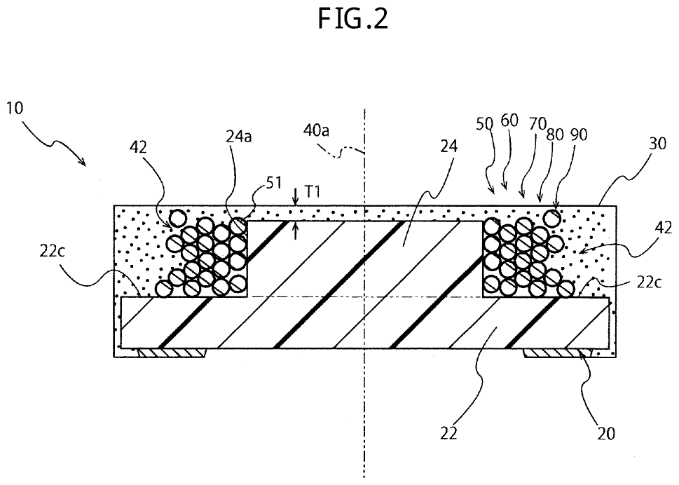

As illustrated in FIG. 2 which is a cross-sectional view, the first magnetic material portion 20 functions as a core in the coil device 10 together with the second magnetic material portion 30 described later. The plate-shaped portion 22 has a larger projected area than the protrusion 24 when viewed from above. The thickness of the plate-shaped portion 22 can be set to about 10 to 40% of the total thickness of the coil device 10, but is not particularly limited. The shape of the plate-shaped portion 22 is not limited only to the substantially rectangular tabular shape, and may be a shape other than the rectangular tabular shape, such as a polygonal plate shape, a circular plate shape, or an elliptical plate shape.

The protruding height of the protrusion 24 is also not particularly limited, but can be set to about 20 to 60% of the total thickness of the coil device 10. The outer peripheral shape of the protrusion 24 illustrated in FIG. 1 is not limited to a circular shape, and may be a shape other than the circular shape, such as an elliptical shape or a polygonal shape, but is preferably a circular shape or an elliptical shape from the viewpoint of winding the wire 40 in close contact with the outer periphery of the protrusion 24.

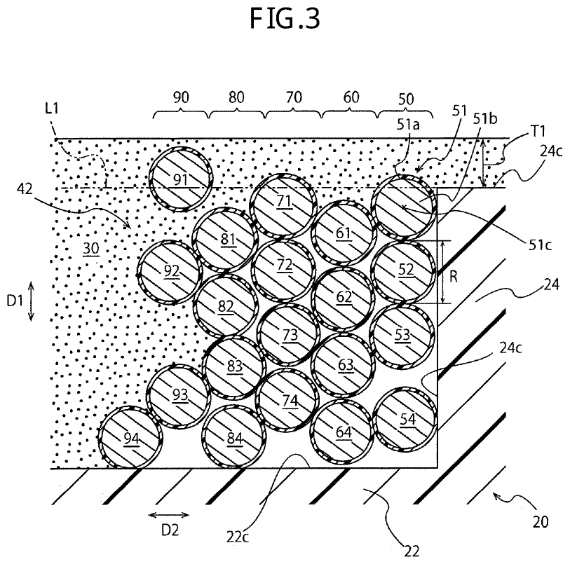

As illustrated in FIG. 1, the wire 40 has a winding portion 42 that forms two or more winding layers wound around the protrusion 24, and a wire end portion 41 drawn out from the winding portion 42. As illustrated in FIG. 3 which is an enlarged cross-sectional view, the wire 40 has a conductive conductor portion (see a conductor portion 51b of FIG. 3 or the like) and an insulating coating portion (see a coating portion 51a of FIG. 3 or the like) covering the conductor portion. In the winding portion 42 in a predetermined cross section as illustrated in FIGS. 2 and 3, a coating portion appears in the outer peripheral portion of a wire cross section (see a first layer uppermost wire cross section 51 of FIG. 3 or the like).

The conductor portion of the wire 40 is made of, for example, Cu, Al, Fe, Ag, Au, phosphor bronze, or the like. Examples of the material of the coating portion formed on the surface of the conductor portion of the wire 40 include polyurethane, polyamideimide, polyimide, polyester, polyester-imide, and polyester-nylon.

A part of the wire 40 is wound around the protrusion 24 to form the winding portion 42. FIG. 2 is a cross-sectional view taken along a predetermined cross section including a winding axis 40a of the winding portion 42, and in FIG. 3 which is a partially enlarged view thereof, wire cross sections 51 to 54, 61 to 64, 71 to 74, 81 to 84, and 91 to 94 which are cross sections of the wire 40 are observed for the number of windings of the wire 40 around the protrusion 24. Although the number of windings of the wire 40 around the protrusion 24 in the coil device 10 illustrated in FIGS. 2 and 3 is 20 turns, the number of windings of the winding portion 42 is not particularly limited.

As illustrated in FIG. 2, the winding portion 42 forms two or more winding layers, and in the embodiment, the winding layers of a first layer 50, a second layer 60, a third layer 70, a fourth layer 80, and a fifth layer 90 are formed. The first to fifth layers 50 to 90 are arranged along a second direction D2 perpendicular to the winding axis 40a. The first layer 50 is directly wound around the protrusion 24, for example, by being pressed against a protrusion side surface 24a of the protrusion 24. The second layer 60 is pressed against the first layer 50 on the inner peripheral side and wound, for example. Similarly to the second layer 60, the third layer 70, the fourth layer 80, and the fifth layer 90 are also pressed against the winding layer on the inner peripheral side and wound. The wire cross sections 51 to 54, 61 to 64, 71 to 74, 81 to 84, and 91 to 94 adjacent to each other in the winding portion 42 are in close contact with each other by fusion of the coating portion or the like. However, a local gap may be formed between the wire cross sections 51 to 54, 61 to 64, 71 to 74, 81 to 84, and 91 to 94 by spring back of the wire 40 or the like.

As described above, the winding portion 42 is preferably formed by winding the wire 40 around the winding portion 42 with a winding machine or the like, so that the first layer 50 of the winding portion 42 approaches or comes into contact with the protrusion 24 or the first to fifth layers 50 to 90 approach or come into contact with each other from the viewpoint of increasing the winding density. However, the winding portion 42 may be formed of an air-core coil. The number of winding layers included in the winding portion 42 is also not particularly limited, and any two or more winding layers can be formed around the winding portion 42. In the winding portion 42, all the winding layers may be pressed against the inner winding layer and wound, or a part or all of the winding layers may be wound with a space from the winding layers on the inner peripheral side.

As illustrated in FIG. 2, the wire 40 is a round wire in which the wire cross sections 51 to 54, 61 to 64, 71 to 74, 81 to 84, and 91 to 94 are substantially circular. However, the wire 40 is not limited to only a round wire, and a rectangular wire having a substantially rectangular cross section may be used. The wire 40 is not limited to only a single wire in which the conductor portion 51b and the coating portion 51a are concentrically formed, and may have conductor portions such as a stranded wire.

As illustrated in FIG. 1, the wire 40 has a pair of wire end portions 41 drawn out from both ends of the winding portion 42, and each wire end portion 41 is connected to a terminal electrode portion (not illustrated) formed on a plate-shaped portion side surface 22a and a plate-shaped portion bottom surface 22b of the plate-shaped portion 22. The terminal electrode portion may be, for example, a metal terminal such as copper or a copper alloy bonded to the plate-shaped portion 22, a baked electrode containing silver, a silver alloy, or the like, or a metal film electrode formed by plating or the like.

As illustrated in FIG. 2, the second magnetic material portion 30 covers at least the winding portion 42 of the wire 40 and the protrusion 24 of the first magnetic material portion 20 and constitutes the core of the coil device 10 together with the first magnetic material portion 20. The second magnetic material portion 30 contains a magnetic material and a resin. The second magnetic material portion 30 contains a magnetic material similarly to the first magnetic material portion 20, but the content ratio of the magnetic material is smaller than that of the first magnetic material portion 20. Since the content ratio of the magnetic material is small, the second magnetic material portion 30 can be disposed around the winding portion 42 in a state of having fluidity at the time of manufacturing, whereby the second magnetic material portion 30 can be brought into close contact with the winding portion 42 from the outer peripheral side and the upper side.

As the magnetic material contained in the second magnetic material portion 30, a metal magnetic material powder or ferrite magnetic material powder similar to those exemplified as the magnetic material powder contained in the first magnetic material portion 20 can be used. Examples of the binder resin contained in the second magnetic material portion 30 include an epoxy resin, a phenol resin, an acrylic resin, a polyester resin, polyimide, polyamideimide, a silicon resin, and a combination thereof, as with the first magnetic material portion 20.

The second magnetic material portion 30 is combined with the first magnetic material portion 20 having only one plate-shaped portion 22 as illustrated in FIGS. 1 and 2, and is disposed not only on the outer peripheral side of the winding portion 42 but also on the upper side of the winding portion 42 and the upper side of the protrusion 24.

The second magnetic material portion 30 is manufactured by compression molding or the like. For example, the second magnetic material portion 30 is obtained by putting an intermediate product in which the winding portion 42 is formed by the wire 40 around the protrusion 24 of the first magnetic material portion 20 and a mixture of the magnetic material powder and the binder resin to be the material of the second magnetic material portion 30 into a cavity and compressing the whole.

The content ratio of the magnetic material in the second magnetic material portion 30 is preferably 50% or more from the viewpoint of improving inductance, and more preferably 70% or more. The magnetic material contained in the second magnetic material portion 30 may be composed of two or more types of magnetic material powder having different mean particle diameters. In such a second magnetic material portion 30, since the particle diameter distribution of the magnetic material powder has peaks and is distributed in a wide range, the magnetic material powder having a small particle size easily enters the inter-wire gap.

FIG. 3 is an enlarged cross-sectional view illustrating a predetermined cross section including the winding axis 40a of the winding portion 42 illustrated in FIG. 2, and the wire cross sections 51 to 54, 61 to 64, 71 to 74, 81 to 84, and 91 to 94 which are cross sections of the wire 40 are observed. In FIG. 3, the wire cross sections 51 to 54, 61 to 64, 71 to 74, 81 to 84, and 91 to 94 which are cross sections of the wire 40 can be observed by the number corresponding to the number of windings (20 turns) of the wire 40 around the protrusion 24.

As illustrated in FIG. 3, the first layer 50 directly wound around the protrusion 24 in the winding portion 42 includes four wire cross sections 51 to 54 of a first layer uppermost wire cross section 51, a first layer second-stage wire cross section 52, a first layer third-stage wire cross section 53, and a first layer fourth-stage wire cross section 54. The first layer uppermost wire cross section 51 is a wire cross section, which is farthest from the plate-shaped portion 22, among the wire cross sections 51 to 54 included in the first layer 50. The first layer fourth-stage wire cross section 54 corresponds to a first layer lowermost wire cross section closest to the plate-shaped portion 22 among the wire cross sections 51 to 54 included in the first layer 50. The first layer 50 means a layer including the wire cross sections 51 to 54 facing the protrusion 24 without sandwiching another wire cross section, and may correspond to the first layer 50 directly wound around the protrusion 24 regardless of whether the wire 40 is formed by winding a wire serving as a raw material around the protrusion 24 to form the winding portion 42 or whether the wire 40 uses an air-core coil.

The first layer uppermost wire cross section 51 includes a portion separated from the plate-shaped portion 22 as compared with a protrusion tip 24c farthest from the plate-shaped portion 22 of the protrusion 24 of the first magnetic material portion 20. That is, in FIG. 3, the first layer uppermost wire cross section 51 has a portion protruding upward, which is the protruding direction of the protrusion 24, from a straight line L1 passing through the protrusion tip 24c and parallel to a plate-shaped portion upper surface 22c. The first layer uppermost wire cross section 51 illustrated in FIG. 3 protrudes upward from the straight line L1 by about 20% of the diameter of the wire cross section in a first direction D1 separated from the plate-shaped portion 22. However, the arrangement of the first layer uppermost wire cross section 51 is not limited only to the example illustrated in FIG. 3.

It is preferable that the coating portion 51a in the first layer uppermost wire cross section 51 is in contact with the protrusion 24 or a gap between the coating portion 51a and the protrusion 24 is narrow. Since the first layer uppermost wire cross section 51 is in contact with or very close to the protrusion 24, it is possible to prevent the magnetic material contained in the second magnetic material portion 30 from entering the winding portion 42 from the winding portion 42 and the second magnetic material portion 30 on the upper side of the protrusion 24. Since the first layer uppermost wire cross section 51 is in contact with the protrusion 24 and protrudes upward from the straight line L1, the first layer uppermost wire cross section 51 is suitably pressed against the protrusion 24 during compression molding or the like, and a problem that a temporary gap that allows passage of the magnetic material powder is formed between the first layer uppermost wire cross section 51 and the protrusion 24 can be prevented.

As illustrated in FIG. 3, the protrusion tip 24c is separated from the plate-shaped portion 22 as compared with a center 51c of the first layer uppermost wire cross section 51. That is, the proportion at which the first layer uppermost wire cross section 51 protrudes upward from the straight line L1 is less than 50% of the diameter of the wire cross section. By disposing the first layer uppermost wire cross section 51 in this manner, it is possible to reduce the possibility that the contact between the first layer uppermost wire cross section 51 and the protrusion 24 is unintentionally released when the pressure during compression molding is increased.

The first layer second-stage wire cross section 52 illustrated in FIG. 3 is disposed on the lower side (plate-shaped portion 22 side) of the first layer uppermost wire cross section 51, the first layer third-stage wire cross section 53 is disposed on the lower side (plate-shaped portion 22 side) of the first layer second-stage wire cross section 52, and the first layer fourth-stage wire cross section 54 is disposed on the lower side (plate-shaped portion 22 side) of the first layer third-stage wire cross section 53. The layers 50 to 90 of the winding portion 42 in the wire 40 are configured by the wire cross sections 51 to 54, 61 to 64, 71 to 74, 81 to 84, and 91 to 94 wound by four turns along the winding axis 40a (see FIG. 2), respectively.

As illustrated in FIG. 3, the second layer 60 wound around the protrusion 24 while overlapping the first layer 50 in the winding portion 42 includes four wire cross sections 61 to 64 of a second layer uppermost wire cross section 61, a second layer second-stage wire cross section 62, a second layer third-stage wire cross section 63, and a second layer fourth-stage wire cross section 64. The second layer uppermost wire cross section 61 is a wire cross section, which is farthest from the plate-shaped portion 22, among the wire cross sections 61 to 64 included in the second layer 60. The second layer fourth-stage wire cross section 64 is a wire cross section closest to the plate-shaped portion 22 among the wire cross sections 61 to 64 included in the second layer 60, and corresponds to a second layer lowermost wire cross section.

The second layer uppermost wire cross section 61 of the second layer 60 is disposed closer to the plate-shaped portion 22 than the first layer uppermost wire cross section 51 of the first layer 50 adjacent to the side closer to the protrusion 24. With such an arrangement, it is possible to reduce the possibility that the position of the second layer uppermost wire cross section 61 is unintentionally displaced when the pressure during compression molding is increased.

As illustrated in FIG. 3, the third layer 70 wound around the protrusion 24 while overlapping the second layer 60 in the winding portion 42 includes four wire cross sections 71 to 74 of a third layer uppermost wire cross section 71, a third layer second-stage wire cross section 72, a third layer third-stage wire cross section 73, and a third layer fourth-stage wire cross section 74. The fourth layer 80 wound around the protrusion 24 while overlapping the third layer 70 in the winding portion 42 includes four wire cross sections 81 to 84 of a fourth layer uppermost wire cross section 81, a fourth layer second-stage wire cross section 82, a fourth layer third-stage wire cross section 83, and a fourth layer fourth-stage wire cross section 84. Similarly, the fifth layer 90 includes four wire cross sections 91 to 94.

In the first to fourth layers 50 to 80 excluding the fifth layer 90 which is the outermost layer, the first to fourth layer uppermost wire cross sections 51 to 81 are disposed in a zigzag manner. That is, the second and fourth layer uppermost wire cross sections 61 and 81 are disposed closer to the plate-shaped portion 22 than the first and third layer uppermost wire cross sections 51 and 71. The shape of such a winding portion 42 is preferable from the viewpoint of preventing the positional displacement of each of the wire cross sections 71 to 74 during compression molding or the like and preventing movement of the magnetic material powder into the winding portion 42.

As illustrated in FIGS. 2 and 3, in the coil device 10, a thickness T1 of the second magnetic material portion 30 covering the protrusion tip 24c along the first direction D1, which is a direction away from the plate-shaped portion 22, is preferably twice or less a diameter R (average diameter when the diameter is not constant) of the wire cross sections 51 to 54, 61 to 64, 71 to 74, 81 to 84, and 91 to 94. In this way, the coil device 10 can be thinned, and the proportion of the first magnetic material portion 20 of the entire deposition of the coil device 10 can be increased to improve the performance of the coil device 10 such as inductance.

As described above, since the first layer uppermost wire cross section 51 comes into contact with or approaches the protrusion 24 and protrudes upward from the straight line L1, the coil device 10 can prevent the magnetic material powder or the like of the second magnetic material portion 30 outside the winding portion 42 from entering the winding portion 42. Accordingly, the coil device 10 can suitably prevent the damage of the coating portion of the wire 40 and the short circuit failure associated therewith.

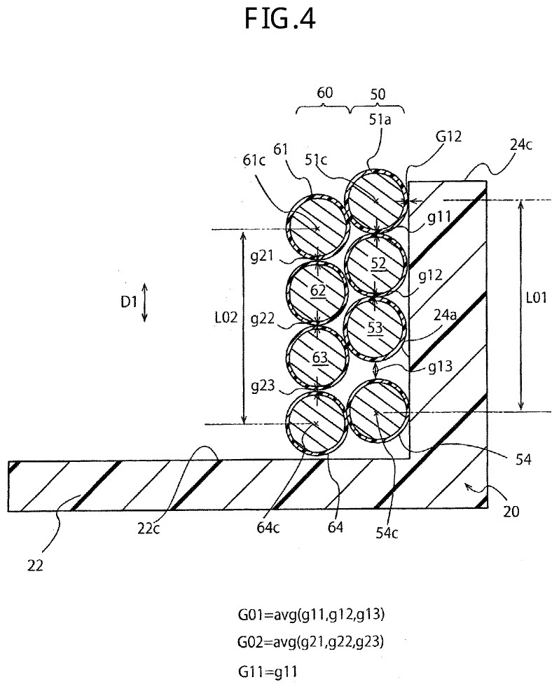

FIG. 4 is a conceptual diagram for describing a distance and a gap width related to the first layer 50 and the second layer 60 in the winding portion 42 illustrated in FIG. 3. In FIG. 4, only the wire cross sections 51 to 54 of the first layer 50, the wire cross sections 61 to 64 of the second layer 60, and the protrusion 24 and the plate-shaped portion 22 of the first magnetic material portion 20 are illustrated.

In the coil device 10, a first average gap width G01, which is an average interval along the first direction D1 between the wire cross sections 51 to 54 included in the first layer 50, is wider than a second average gap width G02, which is an average interval along the first direction D1 between the wire cross sections 61 to 64 included in the second layer 60. As illustrated in FIG. 4, when a gap along the first direction D1 between the first layer uppermost wire cross section 51 and the first layer second-stage wire cross section 52 is denoted as g11, a gap along the first direction D1 between the first layer second-stage wire cross section 52 and the first layer third-stage wire cross section 53 is denoted as g12, and a gap along the first direction D1 between the first layer third-stage wire cross section 53 and the first layer fourth-stage wire cross section 54 is denoted as g13, the first average gap width G01 is an average value of these gaps g11, g12, and g13.

When a gap along the first direction D1 between the second layer uppermost wire cross section 61 and the second layer second-stage wire cross section 62 is denoted as g21, a gap along the first direction D1 between the second layer second-stage wire cross section 62 and the second layer third-stage wire cross section 63 is denoted as g22, and a gap along the first direction D1 between the second layer third-stage wire cross section 63 and the second layer fourth-stage wire cross section 64 is denoted as g23, the second average gap width G02 is an average value of these gaps g21, g22, and g23.

As illustrated in FIG. 4, by making the first average gap width G01 larger than the second average gap width G02, the wire cross sections 61 to 64 of the second layer 60 easily enters undulations on the outer peripheral side of the first layer 50 during compression molding, and a force pressing the wire cross sections 51 to 54 of the first layer against the protrusion 24 becomes strong. Such a coil device 10 can prevent the second magnetic material portion 30 from moving from the outside to the inside of the winding portion 42, and can suitably prevent the coating portion of the wire 40 from being damaged.

As illustrated in FIG. 4, in the coil device 10, a first layer protrusion gap width G12, which is a gap width along the second direction D2 between the first layer uppermost wire cross section 51 and the protrusion 24, is narrower than the first average gap width G01. By narrowing the first layer protrusion gap width G12, it is possible to appropriately prevent a problem that the magnetic material powder moves to the winding portion 42 and the coating portion of the wire 40 is damaged.

As illustrated in FIG. 4, the first layer upper gap width G11, which is a gap width along the first direction D1 between the first layer uppermost wire cross section 51 and the first layer second-stage wire cross section 52 adjacent to the first layer uppermost wire cross section 51 in the first direction D1, is narrower than the first average gap width G01. The first layer upper gap width G11 is the same as the gap g11 defined in the description of the first average gap width G01. By narrowing the first layer upper gap width G11, it is possible to suppress positional displacement of the first layer uppermost wire cross section 51 during compression molding and to prevent a problem that the coating portion 51a of the first layer uppermost wire cross section 51 itself is damaged.

In the coil device 10, a first layer vertical distance L01, which is a distance along the first direction D1 between the first layer fourth-stage wire cross section 54, which is the first layer lowermost wire cross section, and the first layer uppermost wire cross section 51, is longer than a second layer vertical distance L02, which is a distance along the first direction D1 between the second layer fourth-stage wire cross section 64, which is the second layer lowermost wire cross section, and the second layer uppermost wire cross section 61. In such a coil device 10, the entire second layer 60 can be disposed within a short distance with respect to the first direction D1, the winding portion 42 can be formed compactly, and the magnetic characteristics of the coil device can be improved. This is because when the winding portion 42 can be made compact, the volume proportion of the second magnetic material portion 30 and the first magnetic material portion 20 in the coil device 10 can be increased. The first layer vertical distance L01 is determined based on centers 51c, 54c, 61c, and 64c of the wire cross sections 51, 54, 61, and 64.

In the coil device 10, it is particularly important that the gap between the first layer uppermost wire cross section 51 and the protrusion 24 is narrow from the viewpoint of preventing the magnetic material powder from entering the winding portion 42 from the second magnetic material portion 30. The reason is that, for example, the pressurizing direction during compression molding of the coil device 10 as illustrated in FIG. 2 is often the vertical direction (first direction D1), and thus, the moving distance of the particles in the first direction D1 increases. Adhesion between the wire cross sections 51 to 54, 61 to 64, 71 to 74, 81 to 84, and 91 to 94 is relatively easily maintained by contact between the flexible coating portions 51a, and it is also possible to prevent passage of particles by performing a fusion treatment between the coating portions.

As described above, the coil device 10 can prevent the second magnetic material portion 30 from moving from the outside to the inside of the winding portion 42 during compression molding, and can suitably prevent the coating portion of the wire 40 from being damaged.

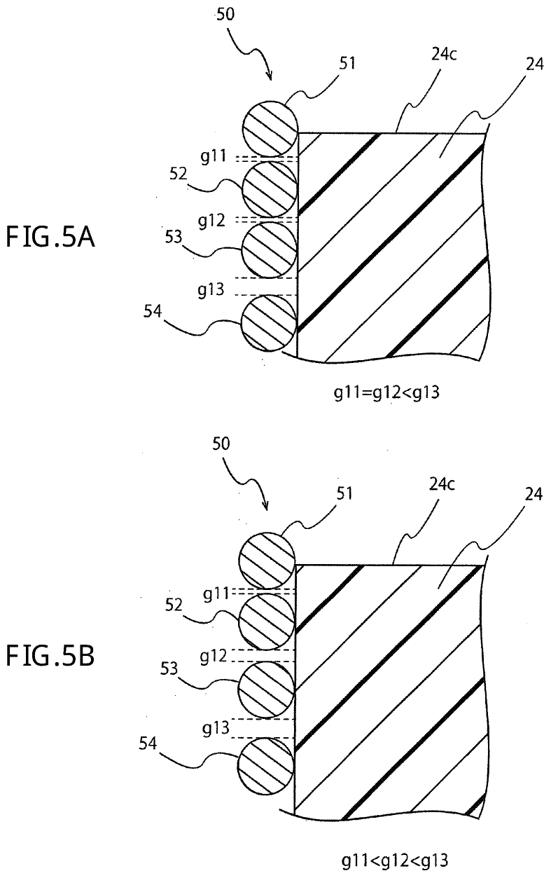

Although the present disclosure has been described above with reference to the embodiments, the technical scope of the present disclosure is not limited to only the above-described embodiments, and it goes without saying that other modifications and embodiments are included in the present disclosure. For example, FIGS. 5A to 7B are conceptual diagrams illustrating a modification of the arrangement of the wire cross sections 51 to 54 included in the first layer 50. In FIGS. 5A to 7B, the wire cross sections 51 to 54 simply represent only the outer shape.

In the first layer 50 according to a first modification illustrated in FIG. 5A, the gap g11 along the first direction D1 between the first layer uppermost wire cross section 51 and the first layer second-stage wire cross section 52 is equal to the gap g12 along the first direction D1 between the first layer second-stage wire cross section 52 and the first layer third-stage wire cross section 53. These g11 and g12 are narrower than the gap g13 along the first direction D1 between the first layer third-stage wire cross section 53 and the first layer fourth-stage wire cross section 54.

In the first layer 50 according to a second modification illustrated in FIG. 5B, the gaps g11, g12, and g13 become narrower as the distance from the plate-shaped portion 22 (see FIGS. 1 to 4) increases, that is, as it goes upward. In the first layer 50 according to the first modification and the second modification, positional displacement of the first layer uppermost wire cross section 51 can be suitably prevented.

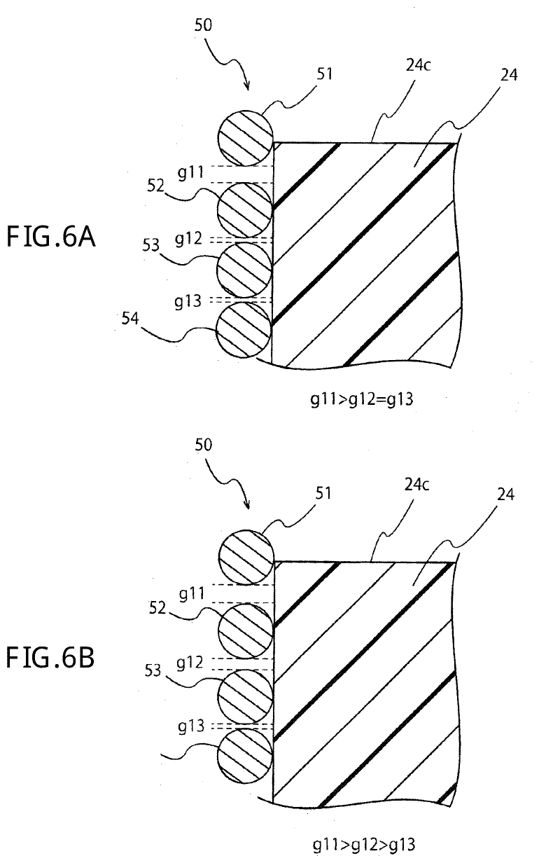

In the first layer 50 according to a third modification illustrated in FIG. 6A, the gap g12 along the first direction D1 between first layer second-stage wire cross section 52 and the first layer third-stage wire cross section 53 is equal to the gap g13 along the first direction D1 between the first layer third-stage wire cross section 53 and the first layer fourth-stage wire cross section 54. These g12 and g13 are narrower than the gap g11 along the first direction D1 between the first layer uppermost wire cross section 51 and the first layer second-stage wire cross section 52.

In the first layer 50 according to a fourth modification illustrated in FIG. 6B, the gaps g11, g12, and g13 become wider as the distance from the plate-shaped portion 22 (see FIGS. 1 to 4) increases, that is, as it goes upward. In the first layer 50 according to the third modification and the fourth modification, the first layer upper gap width G11 (same as g11), which is a gap width along the first direction D1 between the first layer uppermost wire cross section 51 and the first layer second-stage wire cross section 52, is wider than the first average gap width G01 (see FIG. 4). In the first layer 50 according to the third modification and the fourth modification, a force pressing the first layer uppermost wire cross section 51 against the protrusion 24 can be effectively obtained.

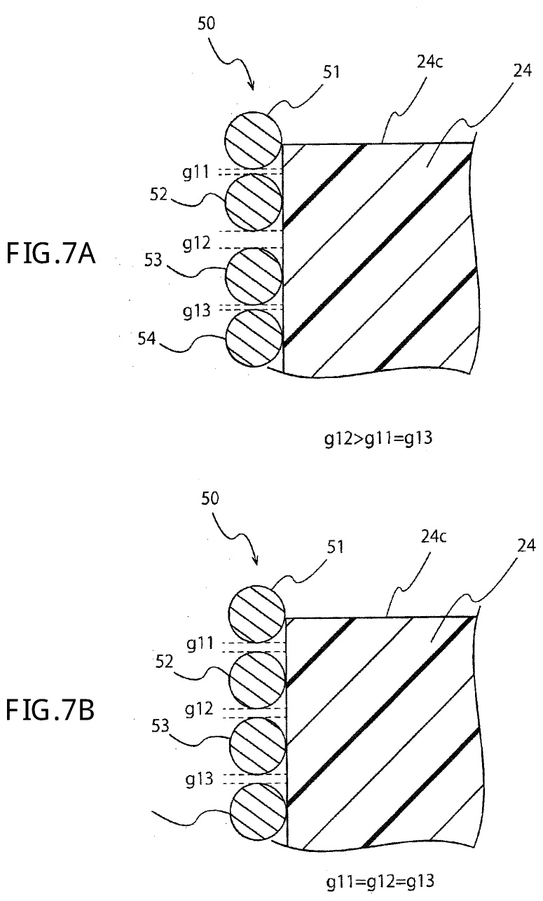

In the first layer 50 according to a fifth modification illustrated in FIG. 7A, the gap g11 along the first direction D1 between the first layer uppermost wire cross section 51 and the first layer second-stage wire cross section 52 is equal to the gap g13 along the first direction D1 between the first layer third-stage wire cross section 53 and the first layer fourth-stage wire cross section 54. These g11 and g13 are narrower than the gap g12 along the first direction D1 between the first layer second-stage wire cross section 52 and the first layer third-stage wire cross section 53.

In the first layer 50 according to a sixth modification illustrated in FIG. 7B, the gaps g11, g12, and g13 are substantially the same. The first layer 50 according to each modification may be adopted instead of the first layer 50 shown in the embodiment.

As illustrated in FIGS. 3 and 4, in the calculation of the first average gap width G01, the second average gap width G02, the first layer upper gap width G11, and the first layer protrusion gap width G12, the contour shapes of the wire cross sections 51 to 54 and 61 to 64 are defined as references, but when the wire is a single line, the first average gap width G01, the second average gap width G02, the first layer upper gap width G11, and the first layer protrusion gap width G12 may be defined on the assumption that there is no coating portion based on the contour shape of only the conductor portion of the wire 40, and there is no problem as long as a unified reference is used.

### REFERENCE SIGNS LIST

10 Coil device
20 First magnetic material portion
22 Plate-shaped portion
22 Plate-shaped portion side surface
22b Plate-shaped portion bottom surface
22 Plate-shaped portion upper surface
24 Protrusion
24a Protrusion side surface
24 Protrusion tip
30 Second magnetic material portion
40 Wire
40 Winding axis
41 Wire end portion
42 Winding portion
51 to 54, 61 to 64, 71 to 74, 81 to 84, 91 to 94 Wire cross section
50 First layer
51 First layer uppermost wire cross section
51a Coating portion
51b Conductor portion
52 First layer second-stage wire cross section
53 First layer third-stage wire cross section
54 First layer fourth-stage wire cross section
60 Second layer
61 Second layer uppermost wire cross section
62 Second layer second-stage wire cross section
63 Second layer third-stage wire cross section
64 Second layer fourth-stage wire cross section
70 Third layer
71 Third layer uppermost wire cross section
72 Third layer second-stage wire cross section
73 Third layer third-stage wire cross section
74 Third layer fourth-stage wire cross section
80 Fourth layer
81 Fourth layer uppermost wire cross section
82 Fourth layer second-stage wire cross section
83 Fourth layer third-stage wire cross section
84 Fourth layer fourth-stage wire cross section
51c, 54c, 61c, 64c Center
90 Fifth layer
D1 First direction
D2 Second direction
G01 First average gap width
G12 First layer protrusion gap width
G11 First layer upper gap width
L01 First layer vertical distance
G02 Second average gap width
L02 Second layer vertical distance
g11, g12, g13, g21, g22, g23 Gap

What is claimed is:

1. A coil device comprising:
a first magnetic material portion containing a magnetic material and having a plate-shaped portion and a protrusion protruding from the plate-shaped portion;
a wire having a winding portion including a conductor portion and an insulating coating portion covering the conductor portion and forming a winding layer wound around the protrusion; and
a second magnetic material portion containing a magnetic material and a resin and covering at least the winding portion and the protrusion,
wherein a first average gap width, which is an average gap width along a first direction away from the plate-shaped portion between wire cross sections included in a first layer directly wound around the protrusion in the winding portion, is wider than a second average gap width, which is an average gap width along the first direction between the wire cross sections included in a second layer wound around the protrusion while overlapping the first layer in the winding portion, and
a first layer protrusion gap width, which is a gap width along a second direction perpendicular to a winding axis between a first layer uppermost wire cross section farthest from the plate-shaped portion among the wire cross sections included in the first layer and the protrusion, is narrower than the first average gap width, in a predetermined cross section including the winding axis of the winding portion in which the wire cross sections, which are cross sections of the wire, are observed.

2. The coil device according to claim 1, wherein a first layer upper gap width, which is a gap width along the first direction between the first layer uppermost wire cross section and a first layer second-stage wire cross section adjacent to the first layer uppermost wire cross section in the first direction, is narrower than the first average gap width.

3. The coil device according to claim 1, wherein a first layer upper gap width along the first direction between the first layer uppermost wire cross section and a first layer second-stage wire cross section adjacent to the first layer uppermost wire cross section in the first direction is wider than the first average gap width.

4. The coil device according to claim 1, wherein the first layer uppermost wire cross section includes a portion separated from the plate-shaped portion as compared with a protrusion tip farthest from the plate-shaped portion of the protrusion.

5. The coil device according to claim 1, wherein a second layer uppermost wire cross section farthest from the plate-shaped portion among the wire cross sections included in the second layer is closer to the plate-shaped portion than the first layer uppermost wire cross section.

6. The coil device according to claim 1, wherein a distance along the first direction between a first layer lowermost wire cross section closest to the plate-shaped portion among the wire cross sections included in the first layer and the first layer uppermost wire cross section is longer than a distance along the first direction between a second layer lowermost wire cross section closest to the plate-shaped portion among the wire cross sections included in the second layer and a second layer uppermost wire cross section farthest from the plate-shaped portion among the wire cross sections included in the second layer.
